(19) United States
(12) Patent Application Publication
(10) Pub. No.: US 2011/0151910 A1
(43) Pub. Date: Jun. 23, 2011

(54) METHOD AND APPARATUS FOR ALLOCATING RESOURCES FOR PHYSICAL CHANNEL IN MOBILE COMMUNICATION SYSTEM

(75) Inventors: Jin Kyu KIM, Daejeon (KR); Bon Tae Koo, Daejeon (KR); Nak Woong Eum, Daejeon (KR)

(73) Assignee: Electronics and Telecommunications Research Institute, Daejeon (KR)

(21) Appl. No.: 12/968,664

(22) Filed: Dec. 15, 2010

(30) Foreign Application Priority Data
Dec. 18, 2009 (KR) 10-2009-0127543
Nov. 4, 2010 (KR) 10-2010-0109020

(51) Int. Cl. H04B 7/00

(52) U.S. Cl. 455/509

(57) ABSTRACT

A method and apparatus for allocating resources for physical channels in a mobile communication system are disclosed. An apparatus for allocating resources, the apparatus comprising: An address generation unit allocating spare resources to a physical channel with reference to resource allocation information stored in a monitoring unit, and generating an address value of a frame generation unit corresponding to frequency and symbol index values of the allocated resources; the frame generation unit storing data to be transmitted via the physical channel in the generated address value to generate subframe data; and the monitoring unit storing an address value corresponding to the physical channel generated by the address generation unit.

### CROSS-REFERENCE TO RELATED APPLICATIONS

This application claims the priority of Korean Patent Application No. 10-2010-0109020 filed on Nov. 4, 2010 and Korean Patent Application No. 10-2009-0127543 filed on Dec. 18, 2009, in the Korean Intellectual Property Office, the disclosure of which is incorporated herein by reference.

### BACKGROUND OF THE INVENTION

1. Field of the Invention

The present invention relates to a method and apparatus for allocating physical channel resources in a mobile communication system and, more particularly, to a resource distribution method and apparatus for effectively disposing various physical channels at frequency and time resources in applying an OFDM modulation scheme used in a next-generation mobile communication system.

2. Description of the Related Art

Mobile communication techniques are advancing from the existing CDMA scheme to an OFDMA scheme having excellent effects in terms of symbol interference or user multiplexing, and coupled with this, a mapping method for effectively disposing physical resources has been evolved.

A scheme of distributing physical resources in downlink and uplink of LTE (Long Term Evolution) spotlighted as next-generation mobile communication standard is a mixture of TDD (time division multiplexing) and FDD (frequency division multiplexing).

TDD refers to a scheme in which uplinks and downlinks use the same frequency band but bi-directional transmission is performed alternately on a time axis, and FDD refers to a scheme in which different frequency bands are allocated for uplink and downlink signals. In this case, signals are transmitted in a pair of frequency bands divided by a certain guard band.

LTE uses a scheme of including data in each of physical resources which have been frequency-divided and transmitting the data in a time-divided time band.

In detail, downlinks and uplinks include radio frames each having a period of 10 ms, and each of the radio frames include ten subframes each having a period of 1 ms.

A MAC layer that controls a physical layer manages data transmission and reception by subframe. One subframe includes two slots, and each slot has a time period of 0.5 ms. Each slot includes several resource blocks, and each resource block includes three, six, or seven OFDM symbols in time axis and includes twelve or twenty-four resource elements in a frequency axis. Twelve or twenty-four resource units correspond to 180 KHz. The number of resource elements constituting each slot is determined according to a transmission system bandwidth. In general, each slot may include 6 (1.4 MHz), 15 (3 MHz), 25 (5 MHz), 50 (10 MHz), 75 (15 MHz), 100 (20 MHz) resource elements.

Thus, one radio frame includes a total of ten subframes or twenty slots, and 0 to 9 are used as subframe numbers, while 0 to 19 are used as slot numbers.

Various types of physical channels are used in a downlink physical layer as follows:
Physical Downlink Share Channel (PDSCH)
Physical Broadcast Channel (PBCH)
Physical Multicast Channel (PMCH)
Physical Control Indicator Channel (PCFICH)
Physical Downlink Control Channel (PDCCH)
Physical Hybrid ARQ Indicator Channel (PHICH)

Each of the physical channels may be divided into a control channel and a data channel. PCFICH, PDCCH, PHICH, PBCH are control channels, and PMCH and PDSCH are data channels.

In order to configure the downlink, six channel signals, synchronization signals, and reference signals must be mapped to resources in subframes. In this case, however, each channel has an independent method of calculating a frequency and symbol position and each method is set to be complicated, so a method for effectively mapping resources to physical channels is required.

### SUMMARY OF THE INVENTION

An aspect of the present invention provides a method and apparatus for allocating resources for physical channels capable of reducing the complexity of resource mapping, facilitating the designing of hardware for calculating a frequency and symbol position value, and simplifying the controlling of individual pieces of hardware.

According to an aspect of the present invention, there is provided a method for allocating resources by using a resource allocation apparatus including an auxiliary memory storing resource information allocated to physical channels, a reference signal, and a synchronization signal in the form of a two-dimensional map, includes: a control channel mapping operation of allocating resources to PCFICH (Physical Control Indicator Channel), PHICH (Physical Hybrid ARQ Indicator Channel), and PDCCH (Physical Downlink Control Channel), control channels among the physical channels; a subframe discriminating operation of checking whether or not a subframe, to which resources are to be allocated, is an MBSFN; a first data channel mapping operation of allocating resources to the synchronization signal, PBCH (Physical Broadcast Channel) and PDSCH (Physical Downlink Share Channel), among the physical channels, and a reference signal for the PDSCH, when it is determined that the subframe, to which resources are to be allocated, is not an MBSFN in the subframe discriminating operation; and a second data channel mapping operation of allocating resources to PMCH (Physical Multicast Channel) among the physical channels, and the reference signal for the PMCH when it is determined that the subframe, to which resources are to be allocated, is an MBSFN in the subframe discriminating operation.

According to an aspect of the present invention, there is provided an apparatus for allocating resources, including: an address generation unit allocating spare resources to a physical channel with reference to resource allocation information stored in a monitoring unit, and generating an address value of a frame generation unit corresponding to frequency and symbol index values of the allocated resources; the frame generation unit storing data to be transmitted via the physical channel in the generated address value to generate subframe data; and the monitoring unit storing an address value corresponding to the physical channel generated by the address generation unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing function blocks of an overall LTE configuration according to an exemplary embodiment of the present invention;

FIG. 2 is a schematic block diagram showing function blocks of a resource allocation apparatus according to an exemplary embodiment of the present invention;

FIG. 3 is a view comparatively showing an address area of a channel data storage unit and an LTE subframe according to an exemplary embodiment of the present invention;

FIG. 4 is a schematic block diagram showing function blocks of an address generation unit of the resource allocation apparatus according to an exemplary embodiment of the present invention;

FIG. 5 is a schematic block diagram showing the entire function blocks of a resource allocation apparatus according to an exemplary embodiment of the present invention;

FIG. 6 is a flow chart illustrating the process of a resource allocation method according to an exemplary embodiment of the present invention;

FIG. 7 is a flow chart illustrating a control channel allocation process of the resource allocation method according to an exemplary embodiment of the present invention;

FIG. 8 is a flow chart illustrating a first data channel mapping process of the resource allocation method according to an exemplary embodiment of the present invention; and

FIG. 9 is a flow chart illustrating a second data channel mapping process of the resource allocation method according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

Before describing a method and apparatus for allocating resources for physical channels in a mobile communication system according to an exemplary embodiment of the present invention, the physical channels of LTE downlink will be first described.

First, the primary functions of control channels among physical channels are as follows.

A PCFICH serves to inform about how many control symbols are configured in a single subframe. Namely, upon seeing the PCFICH value, the amount of OFDM symbols being used as control symbols in a current subframe can be determined.

A PHICH informs a terminal about a reception state of data which has been transmitted to a base station through uplink. Namely, the PHICH delivers information about uplink transmission data in which of resource blocks has failed to be received, through an ARQ signal.

The PDCCH delivers resource allocation information of a data channel configured in uplink and downlink, modulation and coding information, HARQ-related information, layer and antenna configuration information, and the like.

A main function of a data channel, among physical channels, is transmitting data used in an upper layer such as a MAC or an RLC according to a resource allocation method.

A PMCH transmits broadcast service data through a subframe, and a PDSCH transmits control channel or traffic channel data of the RLC through a Non-MBSFN subframe.

Other elements constituting the physical channels include a synchronization signal, a physical signal, used for estimating a time/frequency offset of a receiver and compensating for it or estimating a cell ID value, and a reference signal used for estimating a channel value distorted due to multiple paths or fading.

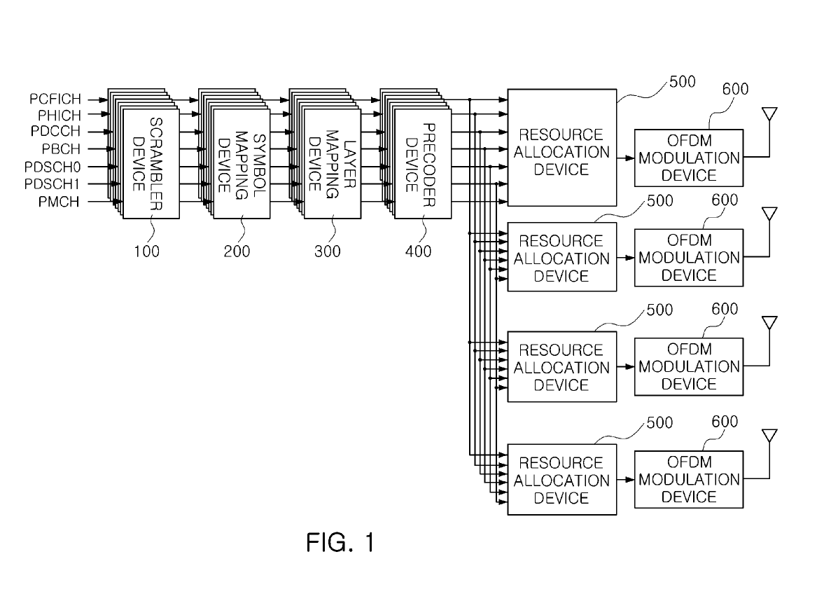

FIG. 1 is a schematic block diagram showing function blocks of an overall LTE configuration according to an exemplary embodiment of the present invention.

With reference to FIG. 1, an LTE system is configured to allocate physical channels to resource blocks, perform OFDM modulation thereon, and transmit the same.

Also, the LTE system performs preprocessing before allocating a plurality of channel data to the resource blocks. First, the respective channels are input in the form of a codeword, to which channel coding has been applied, to a scrambler device 100.

Channel bit data distributed by the scrambler device 100 is modulated to be adaptive to a channel situation according to one of modulation methods among BPSK, QPSK, 16QAM, and 64QAM in a symbol mapping device 200, and then output in the form of complex signals.

A layer mapping device 300 outputs the complex signals to several layers according to respective layer configuration parameters.

A precoder device 400 performs a precoding operation on the layer-mapped signals to output them to one, two, and four antenna ports according to an antenna configuration parameter. Namely, the precoder device 400 generates and outputs transmission signals by antennas for spatial multiplexing or transmit diversity for a MIMO (multi-input multi-output) operation.

A plurality of resource allocation apparatus 500 allocate the transmission signals to frequency/time resources according to a channel allocation method, and finally, an OFDM modulation device 600 performs OFDM modulation on the transmission signals, and transmit the modulated signals through the antennas.

A resource allocation method by physical channels will now be described.

The LTE system may use a maximum of four antennas. Because the allocation method of each antenna is substantially the same, only one antenna will be described.

First, resource allocation methods with respect to control channels PCFICH, PHICH, PDCCH, and PBCH will now be described.

Resources are allocated by a resource element group (REG) including four resources. Also, the REG may be represented as index information (k, l), and in this case, k is a frequency index of the lowest resource element of the REG, and l is an OFDM symbol index.

First, a resource allocation method with respect to the PCFICH will now be described.

The PCFICH is positioned only at the first symbol of a control channel, and a channel length is fixed by 16 symbols. Namely, the PCFICH includes four REGs. Also, the REGs may be disposed to be spaced apart by about ¼ of corresponding bandwidth, to obtain a frequency diversity effect.

Because the PCFICH is always disposed at the first symbol position, the index value 1 is always 0, and the index value k is obtained by using Equation 1 shown below:

k′₀={(N_{sc}^{RB}/2)·(N_{ID}^{cell} mod 2N_{RB}^{DL})} mod(N_{RB}^{DL}·N_{sc}^{RB})

k′₁={(N_{sc}^{RB}/2)·(N_{ID}^{cell} mod 2N_{RB}^{DL})+└N_{RB}^{DL}/2┘·N_{sc}^{RB}/2} mod(N_{RB}^{DL}·N_{sc}^{RB})

k′₂={(N_{sc}^{RB}/2)·(N_{ID}^{cell} mod 2N_{RB}^{DL})+└2N_{RB}^{DL}/2┘·N_{sc}^{RB}/2} mod(N_{RB}^{DL}·N_{sc}^{RB})

k′₃={(N_{sc}^{RB}/2)·(N_{ID}^{cell} mod 2N_{RB}^{DL})+└3N_{RB}^{DL}/2┘·N_{sc}^{RB}/2} mod(N_{RB}^{DL}·N_{sc}^{RB}) [Equation 1]

Second, a resource allocation method with respect to the PHICH will now be described.

The number of OFDM symbols allocated to the PHICH is determined according to a PHICH duration parameter. When the PHICH duration parameter is ‘normal’, only a first OFDM symbol is allocated, and when the PHICH duration parameter is ‘extended’, two or three OFDM symbols are allocated.

In configuring an MBSFN subframe, two OFDM symbols is allocated to the PHICH, and in configuring a non-MBSFN subframe, the PHICH is allocated to three OFDM symbols. Also, the symbols allocated to the PHICH are disposed to be spaced apart by a ⅓ of the distance of the overall bandwidth obtained by using the indexes of the REGs excluding the REG used for the PCFICH, thus obtaining a frequency diversity effect.

Third, a resource allocation method with respect to the PDCCH will now be described.

The PDCCH is disposed at a portion or the entirety of the REGs remaining after being allocated to the PCFICH and the PHICH. When the number of remaining REGs is greater than the number of the REGs of the PDCCHs, the remnants will be filled with <NIL> REG.

A mapping order of the PDCCH is performed according to the REG indexes. First, starting from the lowest frequency index, the PDCCH is assigned in order of OFDM symbols, and when the final OFDM symbol is mapped, the mapping is performed in a direction of increasing the REG frequency index value.

Fourth, a resource allocation method with respect to the PBCH will now be described.

The PBCH is disposed only at a second slot of the first subframe. Namely, the PBCH is allocated only to a first slot number. The PBCH includes four OFDM symbols and is allocated six or some resource blocks up and down always based on a DC (frequency 0) on the frequency axis.

The index values k and l are obtained by using Equation 2 shown below:

$$k = \frac{{N}_{RB}^{DL} {N}_{sc}^{RB}}{2} - 36 + {k}^{′} , \\ {k}^{′} = 0 , 1 , … , 71 \\ l = 0 , 1 , … , 3 \qquad [ Equation 2 ]$$

Next, a resource allocation method with respect to data channels PDSCH and PMCH will now be described.

The type of a data channel used for a data channel area is determined according to whether a subframe is an MBSFN or a non-MBSFN. The PMCH is used for the MBSFN, and the PDSCH is used for the non-MBSFN.

The PDSCH is allocated an empty resource element in a direction in which frequency increases, starting from a first OFDM symbol of a first slot according to a corresponding physical resource block. Here, the empty resource element refers to a resource element which is not allocated to the PBCH, the synchronization signal or the reference signal, and which is in the data channel area to which the PCFICH, the PHICH, and the PDCCH is not allocated. Also, a subframe not allocated to the PDSCH is a non-MBSFN subframe in which the PMCH is not transmitted

The PMCH is allocated a resource element in the same manner as that of the PDSCH. As the reference signal, only a reference signal for MBSFN is used, and the PMCH is allocated only a resource element not allocated to the reference signal. The PMCH is allocated resource elements in a direction in which the frequency index increases from a first OFDM symbol. Also, the corresponding subframe must be an MBSFN subframe in which the PDSCH is not transmitted.

First, parameters used for generating address values of a channel, a synchronization signal, and a reference signal are as follows.

NDLRB: Number of RBs according to system bandwidth

NRBsc: Number of subcarriers existing in one RB

NDLsymb: Number of OFDM symbols existing in one slot

NumAnt: Number of antennas configured in a transmission system

NCP: A cyclic prefix form of an OFDM symbol

DClsymb: Number of OFDM symbols for a control channel currently existing in a subframe

PHICHdur: Number of OFDM symbols continued by the PHICH NcellID: Cell ID information

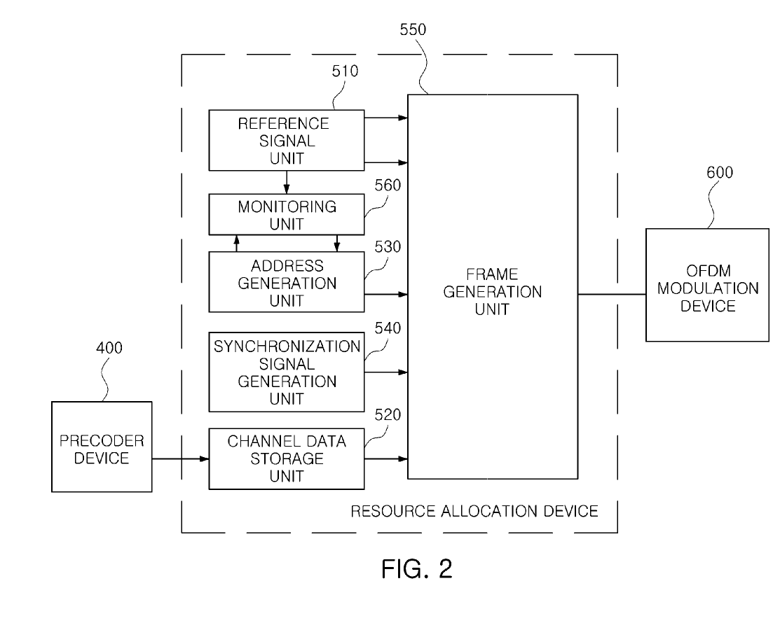

FIG. 2 is a schematic block diagram showing function blocks of a resource allocation apparatus according to an exemplary embodiment of the present invention.

With reference to FIG. 2, the resource allocation apparatus 500 according to an exemplary embodiment of the present invention may be configured to include a reference signal unit 510, a channel data storage unit 520, a frame generation unit 550, an address generation unit 530, a synchronization signal generation unit 540, and a monitoring unit 560.

The reference signal unit 510 may generate a reference signal for a control channel and a data channel, and allocate physical resources to the reference signal. If necessary, elements for allocating resources for a reference signal and elements for generating a reference signal may be separately implemented. The reference signal may be generated differently according to cell characteristics, subframe characteristics, or the like.

The channel data storage unit 520 receives precoded control channel and data channel data from the precoder device, stores data while resource allocation is performed on each physical channel, and transmits the same to the frame generation unit 550.

In general, the channel data storage unit 520 may be implemented as an FIFO (first input first output).

The frame generation unit 550 receives an address and data of the reference signal from the reference signal unit 510, receives resource allocation information with respect to a physical channel from the address generation unit 530, and receives synchronization signal data from the synchronization signal generation unit 540. Also, the frame generation unit 550 receives data to be transmitted via each physical channel from the channel data storage unit 520. The frame generation unit 550 assigns channel data according to the received resource allocation information.

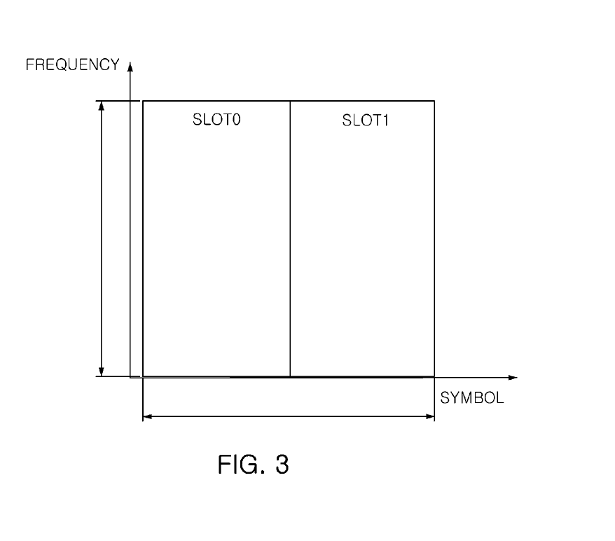

With reference to FIG. 3, the frame generation unit 550 according to an exemplary embodiment of the present invention may store the entirety of data to be transmitted through one subframe. A two-dimensional address value of the frame generation unit 550 may correspond to a symbol and frequency index value of each subframe.

When storing of the subframe data in the frame generation unit 550 is completed, the stored data is transmitted to the OFDM modulation device 600.

The address generation unit 530 generates addresses of the physical channels and an address of the synchronization signal on the frame generation unit 550. The address on the frame generation unit 550 becomes a symbol and frequency index value of a corresponding physical channel or a physical channel allocated to the synchronization signal. The address is generated according to the resource allocation methods with respect the physical channels as described above.

The synchronization signal generation unit 540 generates synchronization signal data. Because a synchronization signal exists only in the case of the non-MBSFN subframe, the synchronization signal generation unit 540 operates only when the subframe is the non-MBSFN subframe.

The monitoring unit 560 receives address information allocated to each physical channel and a synchronization signal from the address generation unit 530, and store resource information, allocated to the physical channel and the synchronization signal, in the form of two-dimensional map by using the received information.

Also, the monitoring unit 560 receives resource information, which has been allocated to the reference signal, from the reference signal unit 510, and store the allocated resource information. Preferably, the amount and two-dimensional structure of memory addresses of the monitoring unit 560 may be implemented to be the same as those of the frame generation unit 550, and the size of the data stored in each memory address of the monitoring unit 560 may be 1 bit. Namely, the frame generation unit 550 and the monitoring unit 560 have the same lengths in the horizontal and vertical axes of the two-dimensional memory, and only the size of the data allocated to each address is different.

For example, when index values (40,56) of the REG are allocated to a physical channel, data of the corresponding physical channel is stored in the addresses (40,56) in the frame generation unit 550, and 1 indicating that resource has been allocated to the addresses (40,56) is stored in the monitoring unit (560).

When compared with the existing resource allocation apparatus, the resource allocation apparatus 500 according to an exemplary embodiment of the present invention additionally includes only the monitoring unit 560, a supplementary memory having a considerably small size when compared with the frame generation unit 550. However, the presence of the monitoring unit 560 has the effect that the resource allocation apparatus 500 can check the situation in which the data is stored in the frame generation unit 550, sequentially, or simply allocate resources by putting the information regarding the situation in which the address generation unit 530 has allocated resources together, without having to recognize them again.

Thus, the resource allocation apparatus 500, according to an exemplary embodiment of the present invention, has a simpler process for resource allocation, it has an improved resource allocation speed compared with the existing resource allocation apparatus. In addition, because the configuration is simple, the address generation unit 530 can be easily implemented by hardware, and the implementation of the address generation unit 530 by hardware can further improve the resource allocation speed.

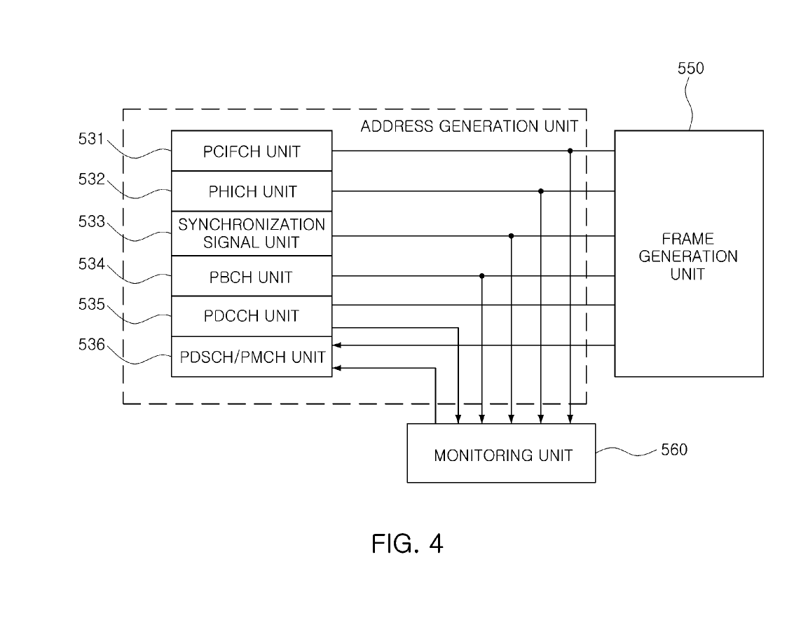

FIG. 4 is a schematic block diagram showing function blocks of an address generation unit of the resource allocation apparatus according to an exemplary embodiment of the present invention.

With reference to FIG. 4, the address generation unit according to an exemplary embodiment of the present invention may be configured to include a PCIFCH unit 531, a PHICH unit 532, a synchronization signal unit 533, a PBCH unit 534, a PDCCH unit 535, and a PDSCH/PMCH unit 536.

The PCIFCH unit 531, the PHICH unit 532, the synchronization signal unit 533, the PBCH unit 534, the PDCCH unit 535, and the PDSCH/PMCH unit 536 allocate resources according to the foregoing resource allocation methods, and transmit an address value of the frame generation unit 550 corresponding to an index value of the allocated resource to the frame generation unit 550.

Also, the PCIFCH unit 531, the PHICH unit 532, the synchronization signal unit 533, and the PBCH unit 534 transmit the address information also to the monitoring unit 560. The monitoring unit 560 stores address information, received from the PCIFCH unit 531, the PHICH unit 532, the synchronization signal unit 533, and the PBCH unit 534, in the form of a two-dimensional map, and transmits resource allocation information to the PDCCH unit 535 and the PDSCH/PMCH unit 536.

The PCIFCH unit 531 generates an address in which the PCIFCH data to be stored in the frame generation unit 550 for resource allocation with respect to the PCIFCH. The PHICH unit 532 generates an address in which the PHICH data is to be stored in the frame generation unit 550 for resource allocation with respect to the PHICH. The synchronization signal unit 533 generates an address in which synchronization signal data is to be stored in the frame generation unit 550 for a resource allocation with respect to a synchronization signal. The PBCH unit 534 generates an address in which the PBCH data is to be stored in the frame generation unit 550 for a resource allocation with respect to the PBCH.

Upon receiving resource allocation information from the monitoring unit 560, the PDCCH unit 535 generates an address in which the PDCCH data is to be stored in the frame generation unit 550 in order to allocate resources for the PDCCH to an empty resource.

Upon receiving resource allocation information from the monitoring unit 560, the PDSCH/PMCH unit 536 generates an address in which the PDSCH or PMCH data is to be stored in the frame generation unit 550 in order to allocate resources for the PDSCH or PMCH to an empty resource.

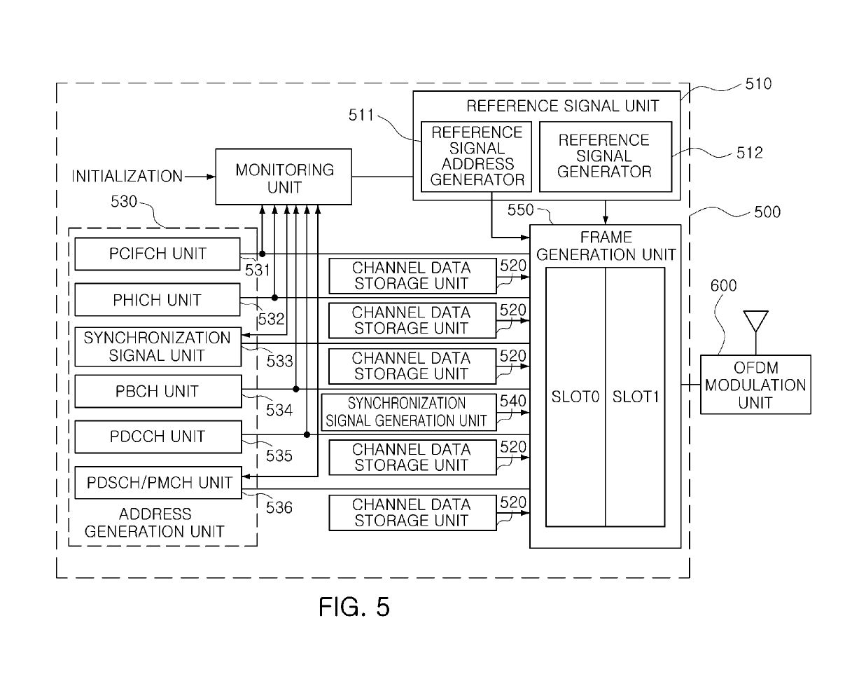

FIG. 5 is a schematic block diagram showing the entire function blocks of a resource allocation apparatus according to an exemplary embodiment of the present invention.

With reference to FIG. 5, the resource allocation apparatus 500 according to an exemplary embodiment of the present invention may be configured to include the reference signal unit 510, the channel data storage unit 520, the frame generation unit 550, the address generation unit 530, the synchronization signal generation unit 540, and the monitoring unit 560.

The reference signal unit 510 may include a reference signal address generator 511 and a reference signal generator 512.

The reference signal address generator 511 generates the address in which reference signal data is to be stored in the frame generation unit 550 for a resource allocation with respect to a reference signal. The reference signal generator 512 generates reference signal data in consideration of cell characteristics, subframe characteristics, and the like.

The channel data storage unit 520, the frame generation unit 550, the address generation unit 530, the synchronization signal generation unit 540, and the monitoring unit 560 have been described in detail above, so a description thereof will be omitted.

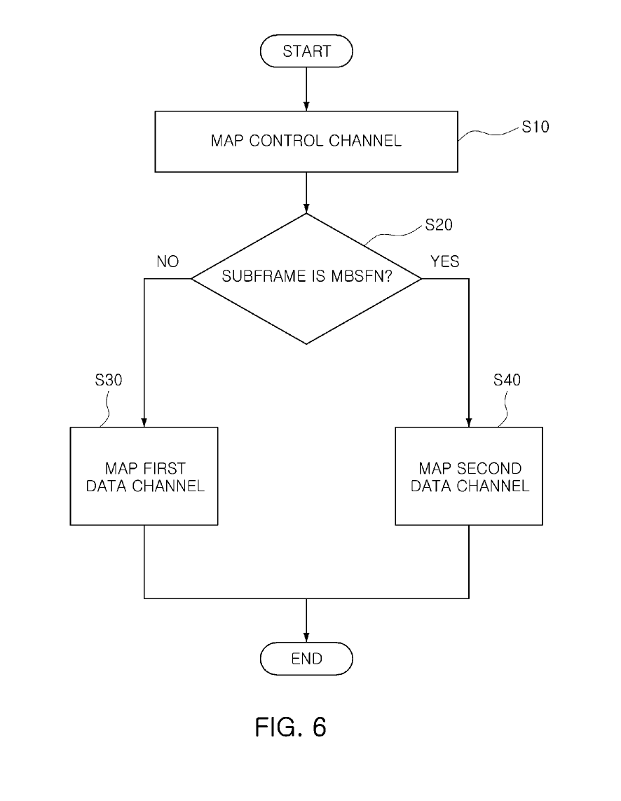

FIG. 6 is a flow chart illustrating the process of a resource allocation method according to an exemplary embodiment of the present invention.

With reference to FIG. 6, a resource allocation method according to an exemplary embodiment of the present invention may include a control channel mapping step (S10), a subframe discriminating step (S20), a first data channel mapping step (S30), and a second data channel mapping step (S40).

The resource allocation method according to an exemplary embodiment of the present invention may be implemented by using a resource allocation apparatus including an auxiliary memory receiving address information allocated to each physical channel, a reference signal and a synchronization signal and storing resource information, allocated to each physical channel, the reference signal, and the synchronization signal, in the form of a two-dimensional map.

In the resource allocation method according to an exemplary embodiment of the present invention, resources are first allocated to physical channels which are not affected by an allocation situation of other channels among control channels. The resource allocation information is stored in the auxiliary memory, and then, when resources are allocated to physical channels, the resource allocation situation in the previous stage is read from the auxiliary memory so as to be recognized.

Also, because resources are allocated in order of control channels and data channels (or allocated to the control channels and the data channel in this order), reference signals of the control channels and the data channels are separated and resources are allocated.

Thus, in the resource allocation method according to an exemplary embodiment of the present invention, resources are preferentially allocated to the respective physical channels, the synchronization signal, and the reference signal (namely, with priority), and the resource allocation situation is stored in the auxiliary memory.

In the control channel mapping step (S10), resources are allocated to the PCFICH, the PHICH, and the PDCCH. When the resources are allocated, the resource allocation information is transmitted to the auxiliary memory and the corresponding resource allocation situation is stored in the auxiliary memory. Also, before allocating resources to the channels, resources are allocated to the reference signal for a control channel.

In the subframe discriminating step (S20), it is determined whether or not a subframe to which resources are to be allocated is an MBSFN. When the subframe is MBSFN, the second data channel mapping step (S40) is performed, and when the subframe is not MBSFN, the first data channel mapping step (S30) is performed.

In the first data channel mapping step (S30), resources are allocated to the synchronization signal, the PBCH, the reference signal, and the PDSCH. When the resources are allocated to the synchronization signal, the PBCH, and the reference signal, the resource allocation information is stored in the auxiliary memory. In allocating resources to the PDSCH, the resource allocation situation stored in the auxiliary memory is read and empty resources are allocated to the PDSCH.

In the second data channel mapping step (S40), resources are allocated to the PMCH and the reference signal for the PMCH. When the resources are allocated to the reference signal, the resource allocation information is stored in the auxiliary memory. In allocating resources to the PMCH, the resource allocation situation stored in the auxiliary memory is read and empty resources are allocated to the PMCH.

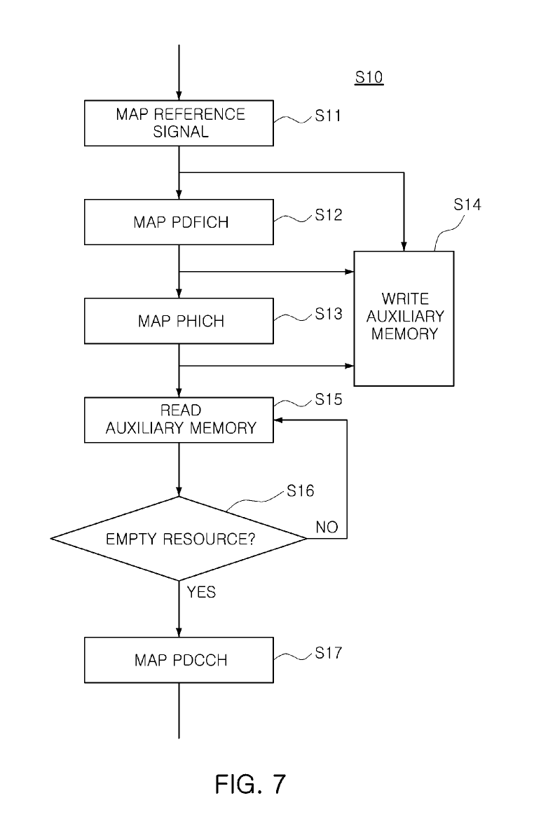

FIG. 7 is a flow chart illustrating a control channel allocation process of the resource allocation method according to an exemplary embodiment of the present invention.

With reference to FIG. 7, the control channel mapping step (S10) according to an exemplary embodiment of the present invention may include a reference signal mapping step (S11), an PCFICH mapping step (S12), a PHICH mapping step (S13), an auxiliary memory writing step (S14), an auxiliary memory reading step (S15), a resource use checking step (S16), and a PDCCH mapping step (S17).

A control channel area is an area to which the PCFICH, the PHICH, and the PDCCH are allocated, and resources are allocated to the three channels by REG. Each REG is changed according to the currently set number of antennas and cyclic prefix type by OFDM symbol, and a start position of each REG may be changed according to NcellID. Also, the case of one antennas and the case of two antennas are treated in the same manner.

In the reference signal mapping step (S11), resources are allocated to the reference signal for a control channel. When resources are allocated to the reference signal, resources are allocated in the same manner when the number of antenna is 1 and when the number of antennas is 2. The number of REGs allocated to one resource block is 8 when the number of antennas is 1 or 2, and 7 when the number of antennas is 4.

Resources are allocated by REG according to the method of storing the reference signal in the address area corresponding to the resource area of the main memory. Also, while allocating resource to the reference signal, the resource allocation information is transmitted to the auxiliary memory.

In the PCFICH mapping step (S12), resources are allocated to the PCFICH. Because the PCIFCH is always positioned at the first OFDM, the index value l is maintained to be 0 and the index value k is calculated according to Equation 1.

The corresponding address on the main memory is calculated by using the index values (k, l) and NcellID, the PCFICH data is stored in the main memory, and the resource allocation information is transmitted to the auxiliary memory.

In the PHICH mapping step (S13), resources are allocated to the PHICH. The PHICH may be mapped into one OFDM symbol or two or three OFDM symbols according to a PHICH duration parameter value. With respect to the PHICH, index values k and l are calculated by using Equation 2 in the same manner as that of the PCFICH.

The corresponding address on the main memory is calculated by using the index values (k, l) and NcellID, the PHICH data is stored in the main memory, and the resource allocation information is transmitted to the auxiliary memory.

In the auxiliary memory writing step (S14), the information regarding allocation of resources in the reference signal mapping step (S11), the PCFICH mapping step (S12), and the PHICH mapping step (S13) is received and stored in the form of two-dimensional map in the auxiliary memory.

Preferably, the number and two-dimensional structure of the memory addresses of the main memory and those of the auxiliary memory are implemented to be the same, and the size of data stored in each memory address of the auxiliary memory may be 1 bit. Namely, the main memory and the auxiliary memory have the same lengths in the horizontal and vertical axes of the two-dimensional memory, and only the size of the data allocated to each address is different.

In the PDCCH mapping step (S17), resources are allocated to the PDCCH. The PDCCH is allocated to an empty REG which is not used for the PCFICH and the PHICH among OFDM symbols of the control channel area. A detailed resource allocation method has been described above, so a repeated description thereof will be omitted.

In this case, however, in order to allocate resources to the PDCCH, the PDCCH must recognize an empty REG which is not used for the PCFICH and PHICH among the OFDM symbols of the control channel area.

To this end, in the auxiliary memory reading step (S15), a data value of an address corresponding to the index values (k, l) of the auxiliary memory is read. In the resource use checking step (S16), the read data value is checked to recognize whether the resource corresponding to the index values (k, l) are allocated resource or empty resource.

In the related art method for calculating the REG address of the PDCCH, when the REG address of a control symbol is given by a configuration parameter, because a portion thereof mapped to the PCFICH and the PHICH must be excluded, a comparison calculation is performed in advance in order to generate an REG address. Comparatively, however, in an exemplary embodiment of the present invention, a symbol index is increased by using a flag memory without performing a complicated calculation process, and as it proceeds while checking the flag memory in a direction in which the frequency index increases, resources can be quickly allocated without a complicated address calculation process.

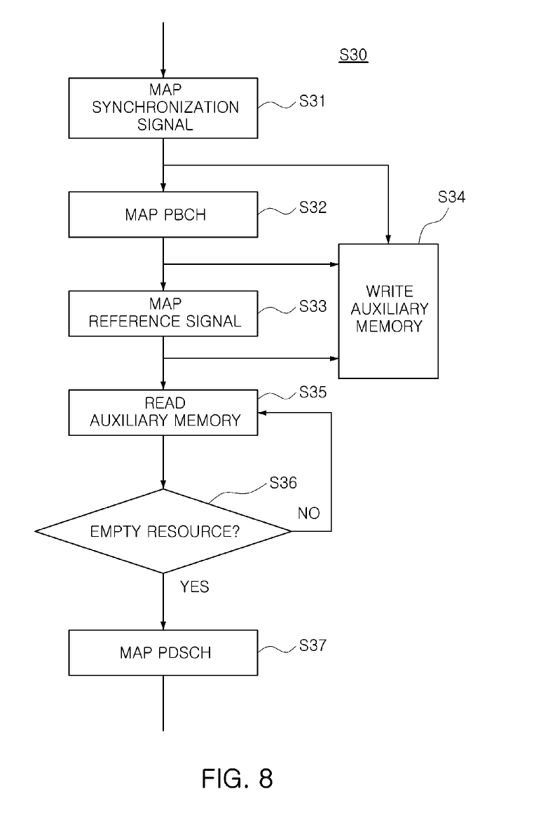

FIG. 8 is a flow chart illustrating a first data channel mapping process of the resource allocation method according to an exemplary embodiment of the present invention.

With reference to FIG. 8, the first data channel mapping process according to an exemplary embodiment of the present invention may include a synchronization signal mapping step (S31), a PBCH mapping step (S32), a reference signal mapping step (S33), an auxiliary memory writing step (S34), an auxiliary memory reading step (S35), a resource use checking step (S36), and a PDSCH mapping step (S37).

In the synchronization signal mapping step (S31), resources are allocated to a synchronization signal. The synchronization signal is allocated to a subframe 0 or subframe 5, and positioned with a size of six resource blocks centering on a DC in the frequency space. Also, because the synchronization signal is positioned at an OFDM where a reference signal is allocated, in the synchronization signal mapping step (S31), allocation is sequentially performed without having to consider a reference signal.

In the PBCH mapping step (S32), resources are allocated to the PBCH. The PBCH is allocated to subframe 0, and like the synchronization signal, the PBCH is positioned with a size of 6RB centering on the DC in a frequency space. However, unlike the synchronization signal, the reference signal must be considered, so allocation is performed on the assumption that the number of antennas is 4. Details of the allocation method are as described above, so a repeated description thereof will be omitted.

One of three types of reference signals of a data channel may be selectively used. First, when the PDSCH is transmitted and multiple antennas are supported, a cell-based reference signal is used. When the PMCH is transmitted, an MBSFN reference signal is used. When a reference signal for a particular UE is used, a UE-based reference signal is used.

Thus, in the reference signal mapping process (S33), resources are allocated to a cell-based reference signal for a data channel.

In the synchronization signal mapping step (S31), the PBCH mapping step (S32), and a reference signal mapping step (S33), resource allocation information is transmitted to the auxiliary memory.

In the auxiliary memory reading step (S34), the information regarding the resource allocation in the synchronization signal mapping step (S31), the PBCH mapping step (S32), and the reference signal mapping step (S33) is received and stored in the form of two-dimensional map in the auxiliary memory.

In the PDSCH mapping step (S37), resources are allocated to the PDSCH. In the PDSCH, resources are allocated to an empty REG among OFDM symbols of the data channel area, and sequentially allocated to a slot 0 and a slot 1. Details of the resource allocation method are as described above, so a repeated description thereof will be omitted.

In this case, in order to allocate resources to the PDSCH, an empty REG must be recognized.

To this end, in the auxiliary memory reading step (S35), a data value of an address corresponding to the index values (k, l) of the auxiliary memory is read. In the resource use checking step (S36), the read data value is checked to recognize whether or not resource corresponding to the index values (k, l) are allocated resource or empty resource.

In the related art method for calculating the REG address of the PDSCH, the portions mapped to the synchronization signal, the reference signal, and the PBCH must be excluded, so a comparison calculation is performed in advance in order to generate an REG address. Comparatively, however, in an exemplary embodiment of the present invention, a symbol index is increased by using a flag memory without performing a complicated calculation process, and it proceeds while checking the flag memory in a direction in which the frequency index increases, resources can be quickly allocated without a complicated address calculation process.

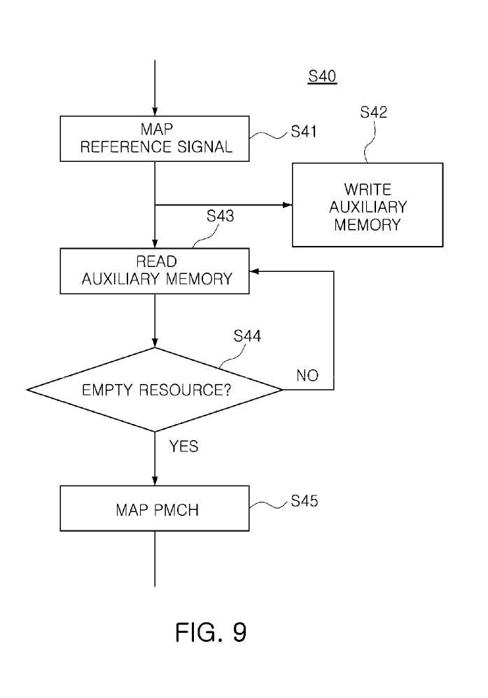

FIG. 9 is a flow chart illustrating the second data channel mapping process of the resource allocation method according to an exemplary embodiment of the present invention.

With reference to FIG. 9, the second data channel mapping process (S40) may include a reference signal mapping step (S41), an auxiliary memory writing step (S42), an auxiliary memory reading step (S43), a resource use checking step (S44), and a PMCH mapping step (S45).

In the reference signal mapping step (S41), resources are allocated to an MBSFN reference signal, and resource allocation information is transmitted to the auxiliary memory.

In the auxiliary memory writing step (S42), the information regarding the resource allocation in the reference signal mapping step (S41) and stored in the form of a two-dimensional map in the auxiliary memory.

In the PMCH mapping step (S45), resources are allocated to the PMCH. The PMCH is allocated to an empty REG among OFDM symbols of the data channel area. Details of the allocation method are as described above, so a repeated description thereof will be omitted.

In this case, in order to allocate resources to the PMCH, an empty REG must be recognized.

To this end, in the auxiliary memory reading step (S43), a data value of an address corresponding to the index values (k, l) of the auxiliary memory is read. In the resource use checking step (S44), the read data value is checked to recognize whether or not resources corresponding to the index values (k, l) are allocated resource or empty resource.

In the related art method for calculating the REG address of the PMCH, the portion mapped to the reference signal must be excluded, so a comparison calculation is performed in advance in order to generate an REG address. Comparatively, however, in an exemplary embodiment of the present invention, a symbol index is increased by using a flag memory without performing a complicated calculation process, and it proceeds while checking the flag memory in a direction in which the frequency index increases, resources can be quickly allocated without a complicated address calculation process.

As set forth above, in the method and apparatus for allocating resources for physical channels in a mobile communication system according to exemplary embodiments of the invention, an address value can be easily generated in allocating resources by using a flag memory, and an effective resource allocation within a given operation time can be guaranteed.

Also, in the method and apparatus for allocating resources for physical channels in a mobile communication system and the LTE system using the same according to exemplary embodiments of the invention, because the complexity of a resource mapping operation can be reduced by simply adding a simple element, hardware can be effectively implemented at a low cost.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for allocating resources, the apparatus comprising:
An address generation unit allocating spare resources to a physical channel with reference to resource allocation information stored in a monitoring unit, and generating an address value of a frame generation unit corresponding to frequency and symbol index values of the allocated resources;
the frame generation unit storing data to be transmitted via the physical channel in the generated address value to generate subframe data; and
the monitoring unit storing an address value corresponding to the physical channel generated by the address generation unit.

2. The apparatus of claim 1, further comprising:
a reference signal unit generating data of a reference signal for a control channel and a data channel, allocating resources to the reference signal, and generating an address value of the frame generation unit corresponding to the frequency and symbol index values of the allocated resources.

3. The apparatus of claim 2, further comprising:
a channel data storage unit storing precoded data received from a precoder device, the precoded data being to be transmitted via the control channel and the data channel; and
a synchronization signal generation unit generating a synchronization signal for the data channel.

4. The apparatus of claim 3, wherein the frame generation unit receives the address value and the reference signal data generated by the reference signal unit and stores the data in an address corresponding to the address value, receives the address value with respect to the synchronization signal generated by the address generation unit and the synchronization signal data generated by the synchronization signal generation unit and stores the data in an address corresponding to the address value, and receives address values with respect to the control channel and data generated by the address generation unit and the data stored in the channel data storage unit via the control channel and the data channel and stores the data value in an address corresponding to the address value.

5. The apparatus of claim 1, wherein the number and two-dimensional structure of memory addresses of the monitoring unit correspond to those of the frame generation unit, and the size of a storage space corresponding to each address of the monitoring unit is 1 bit, and when the address generation unit allocates resources, data of an address of the monitoring unit corresponding to an address of the frame generation unit is toggled.

6. The apparatus of claim 3, wherein address generation unit comprises:
a PCIFCH (Physical Control Indicator Channel) unit allocating resources to PCFICH and generating an address value of the frame generation unit corresponding to an index value of the allocated resource;
a PHICH (Physical Hybrid ARQ Indicator Channel) unit allocating resources to PHICH and generating an address value of the frame generation unit corresponding to an index value of the allocated resource;
a synchronization signal unit allocating resources to the synchronization signal and generating an address value of the frame generation unit corresponding to an index value of the allocated resource;
a PBCH (Physical Broadcast Channel) unit allocating resources to PBCH and generating an address value of the frame generation unit corresponding to an index value of the allocated resource;
a PDCCH (Physical Downlink Control Channel) unit allocating resources to PDCCH by using the resource allocation information stored in the monitoring unit and generating an address value of the frame generation unit corresponding to an index value of the allocated resource; and
a PDSCH (Physical Downlink Share Channel)/PMCH (Physical Multicast Channel) unit allocating resources to PDCCH by using the resource allocation information stored in the monitoring unit and generating an address value of the frame generation unit corresponding to an index value of the allocated resource,
wherein the PCIFCH unit, the PHICH unit, the synchronization signal unit, and the PBCH unit transmit the generated address value to the monitoring unit, respectively.

7. The apparatus of claim 6, wherein the address generation unit generates the addresses in the order of the PCIFCH unit, the PHICH unit, and the PDCCH unit, and when the subframe is not an MBSFN, the address generation unit generates the addresses in order of the synchronization signal unit, the PBCH unit, the reference signal unit, and the PDSCH/PMCH unit, and when the subframe is an MBSFN, the address generation unit generates the addresses in order of the synchronization signal unit and the PDSCH/PMCH unit.

8. A method for allocating resources by using a resource allocation apparatus including an auxiliary memory storing resource information allocated to physical channels, a reference signal, and a synchronization signal in the form of a two-dimensional map, the method comprising:
a control channel mapping operation of allocating resources to PCFICH (Physical Control Indicator Channel), PHICH (Physical Hybrid ARQ Indicator Channel), and PDCCH (Physical Downlink Control Channel), control channels among the physical channels;
a subframe discriminating operation of checking whether or not a subframe, to which resources are to be allocated, is an MBSFN;
a first data channel mapping operation of allocating resources to the synchronization signal, PBCH (Physical Broadcast Channel) and PDSCH (Physical Downlink Share Channel), among the physical channels, and a reference signal for the PDSCH, when it is determined that the subframe, to which resources are to be allocated, is not an MBSFN in the subframe discriminating operation; and
a second data channel mapping operation of allocating resources to PMCH (Physical Multicast Channel) among the physical channels and the reference signal for the PMCH when it is determined that the subframe, to which resources are to be allocated, is an MBSFN in the subframe discriminating operation.

9. The method of claim 8, wherein the number and two-dimensional structure of memory addresses of the auxiliary memory are the same as those of a main memory, and a data length of each address of the auxiliary memory is 1 bit,

10. The method of claim 8, wherein the control channel mapping operation comprises:
a reference signal mapping operation of allocating resource to the reference signal for the control channel and storing the allocated resource information in the auxiliary memory;
a PCFICH mapping operation of allocating resources to the PCFICH and storing the allocated resource information in the auxiliary memory;
a PHICH mapping operation of allocating resources to the PHICH and storing the allocated resource information in the auxiliary memory;
a resource allocation checking operation of checking resources which have not been allocated among resources of the control channel area by using the resource allocation information stored in the auxiliary memory; and
a PDCCH mapping operation of allocating resource, which is checked to have not been allocated among the resources of the control channel area in the resource allocation checking operation, to the PDCCH.

11. The method of claim 10, wherein the two-dimensional address values of the auxiliary memory, in which the resource information allocated in the reference signal mapping operation, the PCFICH mapping operation, and the PHICH mapping operation, correspond to frequency and symbol index values of the allocated resources.

12. The method of claim 8, wherein the first data channel mapping operation comprises:
a synchronization signal mapping operation of allocating resource to the synchronization signal for the data channel and storing the allocated resource information in the auxiliary memory;
a PBCH mapping operation of allocating resources to the PBCH and storing the allocated resource information in the auxiliary memory;
a reference signal mapping operation of allocating resources to the reference signal for the PDSCH and storing the allocated resource information in the auxiliary memory;
a resource allocation checking operation of checking resources which have not been allocated among resources of the data channel area by using the resource allocation information stored in the auxiliary memory; and
a PDSCH mapping operation of allocating resource, which is checked to have not been allocated among the resources of the data channel area in the resource allocation checking operation, to the PDSCH.

13. The method of claim 12, wherein the two-dimensional address values of the auxiliary memory, in which the resource information allocated in the synchronization signal mapping operation, the PBCH mapping operation, and the reference signal mapping operation for the PDSCH, correspond to frequency and symbol index values of the allocated resources.

14. The method of claim 8, wherein the second data channel mapping operation comprises:
a reference signal mapping operation of allocating resources to the reference signal for the PMCH and storing the allocated resource information in the auxiliary memory;
a resource allocation checking operation of checking resources which have not been allocated among resources of the data channel area by using the resource allocation information stored in the auxiliary memory; and
a PMCH mapping operation of allocating resource, which is checked to have not been allocated among the resources of the data channel area in the resource allocation checking operation, to the PMCH.

15. The method of claim 14, wherein the two-dimensional address values of the auxiliary memory, in which the resource information allocated in the reference signal mapping operation for the PMCH, correspond to frequency and symbol index values of the allocated resource.
